(19) United States
(12) Patent Application Publication
(10) Pub. No.: US 2025/0390295 A1
(43) Pub. Date: Dec. 25, 2025

(54) SOFTWARE DEVELOPMENT PROCESS WITH MULTIPLE LARGE LANGUAGE MODEL AGENTS

(71) Applicant: Dell Products L.P., Round Rock, TX (US)

(72) Inventors: Tianyu Ma, Shanghai (CN); Zijia Wang, London (GB); Guangliang Lei, Shanghai (CN); Li Xie, Shanghai (CN)

(21) Appl. No.: 18/760,149

(22) Filed: Jul. 1, 2024

(30) Foreign Application Priority Data
Jun. 25, 2024 (CN) 202410830894.0

(51) Int. Cl. G06F 8/71; G06Q 10/04

(52) U.S. Cl. CPC G06F 8/71; G06Q 10/04

(57) ABSTRACT

A method in an illustrative embodiment comprises configuring a software development process to include at least first and second software-based agents for interacting with one another and with at least one large language model (LLM). The method further comprises assigning a first role in the software development process to the first software-based agent, assigning a second role in the software development process to the second software-based agent, initiating interactions between the first and second software-based agents and between each of the first and second software-based agents and the at least one LLM, determining estimates for completion of respective work items of the software development process based at least in part on the interactions, and adjusting one or more characteristics of the software development process based at least in part on the estimates. The software development process is illustratively part of a continuous integration/continuous deployment (CI/CD) system.

### RELATED APPLICATION

The present application claims priority to Chinese Patent Application No. 202410830894.0, filed Jun. 25, 2024, and entitled “Software Development Process with Multiple Large Language Model Agents,” which is incorporated by reference herein in its entirety.

### FIELD

The field relates generally to computer software, and more particularly to software development processes.

### BACKGROUND

Software development processes typically include multiple environments, such as one or more development environments, an integration testing environment, a staging environment, and a production environment. New software code may be created by individual developers or small teams of developers in respective ones of the development environments. The integration environment provides a common environment where software code from the multiple developers is combined and tested before being provided to the staging environment. The staging environment is designed to emulate the production environment and may be used for final testing, review and approval before new software code is deployed in production applications in the production environment. Software development processes generally implement continuous integration/continuous deployment (CI/CD) functionality to enable frequent and reliable delivery of code changes for software.

### SUMMARY

Illustrative embodiments of the present disclosure provide software development processes with multiple large language model (LLM) agents. For example, in some embodiments, multiple LLM agents are configured to interact with an LLM model in order to automatically generate estimates for completion of respective work items in a software development process. The software development process is then adjusted based at least in part on the automatically generated estimates. In some embodiments implementing a so-called agile software development process, the estimates may comprise respective “story points” and descriptions of the respective work items are referred to as “user stories.” Such embodiments illustratively configure the multiple LLM agents to provide automated story point generation, also referred to as “story pointing,” for user stories describing respective work items in the agile software development process. Numerous other software development process configurations comprising multiple LLM agents can be used in other embodiments.

In one embodiment, a method comprises configuring a software development process to include at least first and second software-based agents for interacting with one another and with at least one LLM, assigning a first role in the software development process to the first software-based agent, assigning a second role in the software development process, different than the first role in the software development process, to the second software-based agent, initiating interactions between the first and second software-based agents and between each of the first and second software-based agents and the at least one LLM, determining estimates for completion of respective work items of the software development process based at least in part on the interactions, and adjusting one or more characteristics of the software development process based at least in part on the estimates.

The first and second software-based agents are also referred to herein as respective LLM agents, and in illustrative embodiments are configured to interact with the same LLM. For example, the LLM may be viewed as a core controller or other core computation engine for each of the multiple LLM agents. In some embodiments, the LLM is implemented on one or more external servers or other external processing platform that is separate from the LLM agents. Alternatively, the LLM in some embodiments is at least partially implemented within one or more of the LLM agents.

The multiple LLM agents and the associated software development process in some embodiments are illustratively part of a CI/CD system that controls integration, deployment and/or other aspects of software development for applications executed by host devices of a host platform coupled to the CI/CD system over at least one network, although other arrangements can be utilized in other embodiments.

In some embodiments, the one or more applications more particularly comprise respective microservices, although the disclosed techniques can be applied to a wide variety of other applications in addition to or in place of microservices.

The software development process in some embodiments more particularly comprises an agile software development process, and the estimates comprise respective story point values of the agile software development process. The story point values are illustratively generated based at least in part on respective user stories providing descriptions of the respective work items of the agile software development process.

In some embodiments, one or more of the estimates for completion of respective work items of the software development process are generated at least in part by at least one of the first and second software-based agents.

Additionally or alternatively, one or more of the estimates for completion of respective work items of the software development process may be generated at least in part by the at least one LLM.

In some embodiments, the above-noted method further comprises training the at least one LLM.

For example, the at least one LLM may illustratively comprise a generative pre-trained transformer (GPT) model. In such an embodiment, training the at least one LLM may more particularly comprise fine-tuning the GPT model to generate estimates as respective story point values.

As another example, training the at least one LLM in some embodiments comprises pre-training a given LLM utilizing a plurality of completed user stories and respective corresponding story point values. A given one of the user stories is illustratively associated with one or more code changes to at least one application.

In some embodiments, the first role assigned to the first software-based agent comprises a product owner role focused on a relationship between implementation effort and story points, and the second role assigned to the second software-based agent comprises a software engineer role focused on a relationship between user story requirements and implementation effort. Other roles in the software development process can be assigned to respective LLM agents in other embodiments.

At least one of the first and second software-based agents is illustratively configured to incorporate self-reflection functionality to determine one or more aspects of its corresponding relationship focus.

These and other illustrative embodiments disclosed herein include, without limitation, methods, apparatus, systems and computer program products comprising processor-readable storage media.

### BRIEF DESCRIPTION OF THE DRAWINGS

FIG. 1 is a block diagram of an information processing system configured to implement a software development process utilizing multiple LLM agents in an illustrative embodiment.

FIG. 2 shows an example of a host platform in an illustrative embodiment.

FIG. 3 shows another example of a host platform and further shows its interaction with an associated storage system in an illustrative embodiment.

FIG. 4 is a flow diagram of an example method for implementing a software development process utilizing multiple LLM agents in an illustrative embodiment.

FIG. 5 shows an example of automated story pointing in a software development process utilizing multiple LLM agents in an illustrative embodiment.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that these and other embodiments are not restricted to the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other cloud-based system that includes one or more clouds hosting multiple tenants that share cloud resources, as well as other types of systems comprising a combination of cloud and edge infrastructure. Numerous different types of enterprise computing and storage systems are also encompassed by the term “information processing system” as that term is broadly used herein.

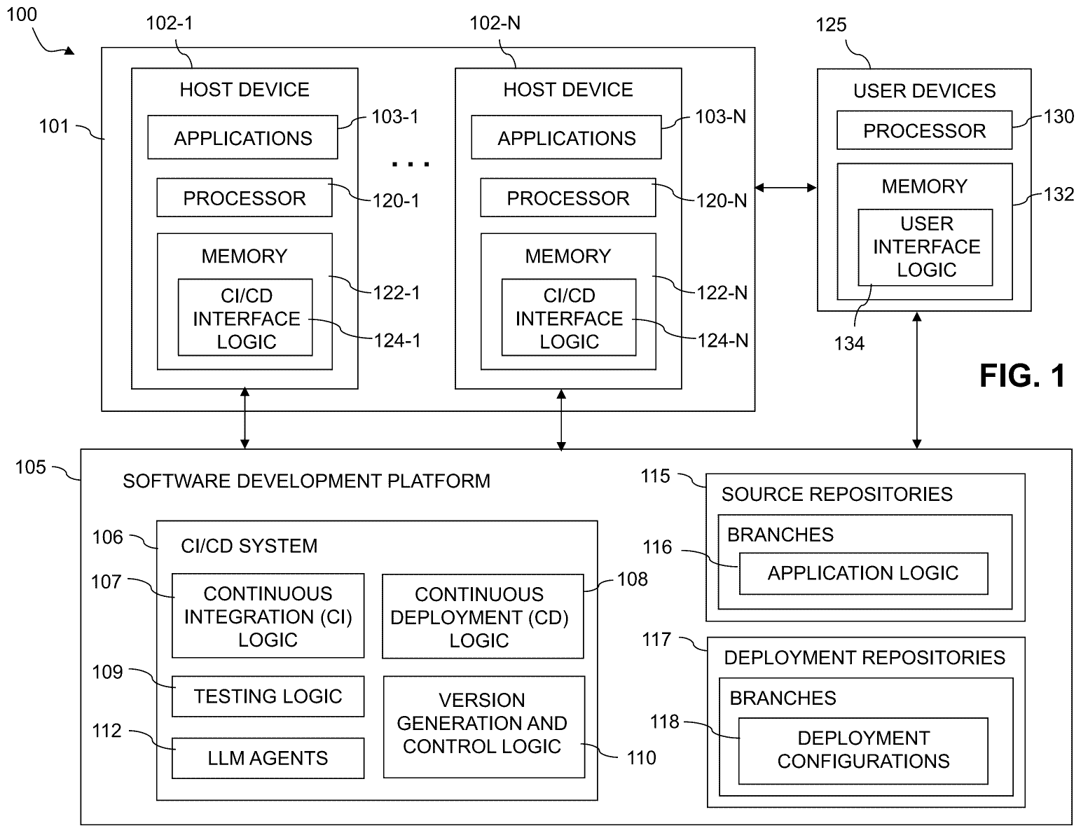

FIG. 1 shows an information processing system 100 configured in accordance with an illustrative embodiment. The information processing system 100 comprises a host platform 101 that includes a plurality of host devices 102-1, . . . 102-N, collectively referred to as host devices 102. The host devices 102 execute respective sets of one or more applications 103-1, . . . 103-N, collectively referred to as applications 103. It should be noted that the term “host device” as used herein is intended to be broadly construed, so as encompass, for example, at least one server, as well as a wide variety of additional or alternative types and arrangements of processing devices. A given one of the host devices 102 can therefore comprise a host system that includes multiple distinct devices of various types. Also, the term “application” as used herein is intended to be broadly construed, so as to encompass, for example, at least one microservice, and/or any of a wide variety of other types and arrangements of software code. In some embodiments, at least a portion of the applications 103 executing on the host platform 101 comprise respective microservices. These and other applications 103 are executed by the host devices 102 on behalf of one or more users of the system 100.

The host platform 101 interacts with an example software development platform 105 that illustratively comprises a continuous integration and continuous deployment (CI/CD) system 106, where the term “deployment” as broadly used herein is intended to encompass delivery, such that CI/CD as that term is used herein refers generally to continuous integration, continuous deployment and/or continuous delivery. Such functions or portions thereof are considered to be examples of a “software development process” as that term is broadly used herein. A wide variety of other types of software development processes may be utilized in other embodiments, illustratively relating to integration, deployment and/or other aspects of software development for one or more of the applications 103 executed by one or more of the host devices 102 of the host platform 101.

The CI/CD system 106 in some embodiments implements one or more CI/CD pipelines for integrating and deploying software code of the applications 103 to the host platform 101. Such CI/CD pipelines of the CI/CD system utilize CI/CD system components that illustratively include CI logic 107, CD logic 108, testing logic 109, version generation and control logic 110, and multiple LLM agents 112. The CI/CD pipelines utilize source repositories 115 comprising application logic 116 of at least a subset of the applications 103, and deployment repositories 117 comprising deployment configurations 118 of at least a subset of the applications 103. The application logic 116 is illustratively part of one or more branches of at least one of the source repositories 115, such as at least one developer branch and a main branch, also referred to as a production branch. Similarly, the deployment configurations 118 are illustratively part of one or more branches of at least one of the deployment repositories 117, such as at least one developer branch and a main branch or a production branch. Other types and arrangements of source and deployment repositories 115 and 117 and their respective branches can be used in other embodiments. It is also to be appreciated that additional or alternative components can be implemented in the CI/CD system 106 and software development platform 105 in other embodiments.

The CI/CD system 106 may comprise, for example, a commercially-available CI/CD system such as Jenkins, Jira, and/or other types of DevOps tools, suitably modified in the manner disclosed herein to provide software development processes utilizing the multiple LLM agents 112 to perform automated story pointing and possibly additional or alternative functions in the CI/CD system 106.

For example, in some embodiments, the CI/CD system 106 via the LLM agents 112 implements automated story pointing to generate estimates in the form of respective story point values, where a given story point value provides an estimate of an amount of development effort required to complete a corresponding work item of a software development process. The CI/CD system 106 utilizes the automatically-generated story point values to adjust one or more characteristics of the software development process, such as, for example, adjusting the duration, sequencing, scheduling and/or other characteristics of a plurality of tasks or other work items performed by particular development personnel utilizing particular development resources to carry out and complete the software development process.

The source repositories 115 and deployment repositories 117 are illustratively implemented as separate source and deployment repositories, and may comprise, for example, repositories that have respective distinct sets of one or more branches, such as at least one developer branch and at least one main or production branch, for a given microservice or other application. In other embodiments, the source repositories 115 and deployment repositories 117 may be combined into a single common repository for application logic 116 and deployment configurations 118.

Although the source repositories 115 and the deployment repositories 117 are illustrated in the figure as being part of the software development platform 105, one or more such repositories in other embodiments can instead be implemented at least in part on one or more separate processing platforms that are external to the software development platform 105 that includes the CI/CD system 106. Numerous other arrangements of multiple processing platforms can be used to implement the software development platform 105 in other embodiments.

Also included in the system 100 are one or more sets of user devices 125. Different ones of the user devices 125 may be in communication with the host platform 101 and the software development platform 105. For example, users of the applications 103 deployed on the host platform 101 may access the host platform 101 via respective ones of a first set of user devices in the user devices 125, and users of the software development platform 105 may access the software development platform 105 via respective ones of a second set of user devices in the user devices 125. One or more of the user devices 125 may each provide certain users, such as administrators, developers, or other users, access to both the host platform 101 and the software development platform 105. The term “user” herein is intended to be broadly construed so as to encompass numerous arrangements of human, hardware, software or firmware entities, as well as combinations of such entities.

The host platform 101, software development platform 105 and user devices 125 illustratively communicate with one another over one or more networks that are not explicitly shown in the figure. For example, such a network in some embodiments illustratively utilizes protocols such as Transmission Control Protocol (TCP) and Internet Protocol (IP), and is therefore referred to herein as a TCP/IP network, although it is to be appreciated that the network can operate using additional or alternative protocols.

Accordingly, communications between the components of system 100 can take place over additional or alternative networks, including a global computer network such as the Internet, a wide area network (WAN), a local area network (LAN), a satellite network, a telephone or cable network, a cellular network such as 4G or 5G cellular network, a wireless network such as a WiFi or WiMAX network, or various portions or combinations of these and other types of networks. The system 100 in some embodiments may therefore comprise one or more TCP/IP networks and/or other types of networks each comprising processing devices configured to communicate using TCP, IP and/or other communication protocols.

The host platform 101 and the software development platform 105 illustratively comprise respective distinct processing platforms each implemented using one or more processing devices each having a processor and a memory, possibly implementing virtual machines and/or containers, although numerous other configurations are possible. Such processing platforms or portions thereof can be provided to users at least in part utilizing one or more of a Platform-as-a-Service (PaaS) model, an Infrastructure-as-a-Service (IaaS) model, a Function-as-a-Service (FaaS) and/or a Storage-as-a-Service (STaaS) model. In some embodiments, at least portions of the host platform 101 and the software development platform 105 may be implemented at least in part on a common processing platform. These and other processing platforms utilized to implement at least a portion of the system 100 can comprise, for example, cloud infrastructure, edge infrastructure, enterprise infrastructure and/or other arrangements of processing devices comprising processors and memory. For example, the cloud infrastructure may include one or more public clouds, one or more private clouds and/or one or more hybrid clouds. As another example, portions of information processing system 100 may be part of one or more edge computing platforms.

The host devices 102 of the host platform 101 illustratively comprise respective processing devices that in the present embodiment include corresponding instances of processors 120-1, . . . 120-N and memories 122-1, . . . 122-N, collectively referred to as processors 120 and memories 122, with the memories 122 storing software code that implements respective instances of CI/CD interface logic 124-1, . . . 124-N, collectively referred to as CI/CD interface logic 124. The CI/CD interface logic 124 is illustratively configured for interfacing the host devices 102 with the CI/CD system 106 of the software development platform 105, in order to facilitate integration, deployment and/or other aspects relating to development of software code for the applications 103, in the manner described elsewhere herein.

The user devices 125 also comprise respective instances of processor 130 and memory 132, the latter storing software code that implements respective instances of user interface logic 134, so as to allow a given one of the user devices 125 to interact with the host platform 101 and/or the software development platform 105.

As mentioned previously, the applications 103 in some embodiments comprise respective microservices, although it is to be appreciated that the disclosed techniques can be adapted in a straightforward manner for use with software development processes involving a wide variety of other types of applications. In the microservice context, the application logic of a source repository is more particularly referred to herein as “business logic,” as such logic implements the functionality of the microservice within the system 100. Terms such as “application logic,” “business logic” and “deployment configuration” as used herein are intended to be broadly construed, and should not be viewed as being limited in any way to the features of the illustrative embodiments described herein.

The operation of the multiple LLM agents 112 of the CI/CD system 106 will now be described in additional detail. In this embodiment, the LLM agents 112 are configured to interact with at least one LLM model in order to automatically generate estimates for completion of respective work items in a software development process of the CI/CD system 106. The software development process is then adjusted based at least in part on the automatically generated estimates.

For example, in some embodiments, the software development process illustratively comprises a so-called agile software development process, in which the estimates may comprise respective “story points” and descriptions of the respective work items are referred to as “user stories.”

Some embodiments therefore configure the LLM agents 112 to provide automated story point generation, also referred to as “story pointing,” for user stories describing respective work items in the agile software development process. Numerous other software development process configurations comprising LLM agents 112 can be used in other embodiments.

In operation, a software development process of the CI/CD system 106 is configured to include at least first and second software-based agents for interacting with one another and with at least one LLM. The first and second software-based agents illustratively comprise respective ones of the LLM agents 112. Such LLM agents are examples of what are more generally referred to herein as “software-based agents,” as such agents are implemented substantially or primarily in the form of software executing on the software development platform 105. Other types of software-based agents can be used in other embodiments, and the term software-based agent as used herein is intended to be broadly construed.

Although only first and second software-based agents are referred to in some of the following description, it is to be appreciated that the LLM agents 112 can comprise any desired number of agents, each potentially assigned a different role within the software development process.

The LLM agents 112 are illustratively configured to interact with one or more LLMs, which in some embodiments may be part of at least one of the LLM agents 112. For example, a given LLM agent as that term is broadly used herein can incorporate at least a portion of an LLM as a core controller or other core computation engine of the LLM agent. In some embodiments, the LLM agents 112 are configured to interact with the same LLM. For example, the LLM may be viewed as a core controller or other core computation engine for each of the multiple LLM agents.

Additionally or alternatively, in some embodiments, the LLM is implemented at least in part on one or more external servers or other external processing platform that is separate from the LLM agents 112. For example, the LLM agents 112 can be configured to access one or more external LLMs, such as one or more LLMs accessible on other processing platforms over one or more networks.

The one or more LLMs associated with the LLM agents 112 are therefore not explicitly shown in the figure, as such LLMs may be part of the LLM agents 112 and/or external to the software development platform 105.

As indicated previously, in some embodiments, the LLM agents 112 share a common LLM, but numerous other arrangements are possible. For example, different fine-tuned instances of a given LLM may be associated with respective different ones of the LLM agents 112. Again, such components can be internal to an LLM agent or external to the LLM agent, and the term “LLM agent” as used herein is therefore intended to be broadly construed. In some embodiments, a given LLM agent supplements an LLM with additional functionality that illustratively includes, for example, short-term and long-term memory, self-reflection functionality, chain of thoughts (CoT) functionality, subgoal decomposition functionality, and additional or alternative types of LLM agent functionality.

In some embodiments, the CI/CD system 106 is illustratively configured to assign a first role in the software development process to a first one of the LLM agents 112, and to assign a second role in the software development process, different than the first role in the software development process, to a second one of the LLM agents 112. Again, there may be more than two LLM agents 112 in other embodiments.

The CI/CD system 106 is further configured to initiate interactions between the first and second LLM agents 112 and between each of the first and second LLM agents 112 and the at least one LLM. Additionally, the CI/CD system 106 is configured to determine estimates for completion of respective work items of the software development process based at least in part on the interactions, and to adjust one or more characteristics of the software development process based at least in part on the estimates. Although these and other functions are described in the context of some embodiments as being performed by the CI/CD system 106, such functions in other embodiments can be performed by other system components comprising one or more processing devices, each comprising a processor and a memory, with the processor being coupled to the memory.

In some embodiments, the CI/CD system 106 implements an agile software development process, and generates estimates in the form of respective story point values of the agile software development process. The story point values are illustratively generated based at least in part on respective user stories providing descriptions of respective work items of the agile software development process. Other types of software development processes and associated estimates can be used in other embodiments. The CI/CD system 106 utilizes the generated story point values or other estimates in controlling one or more aspects of the corresponding software development process. For example, the estimates can be used to control various aspects of integration, deployment and/or delivery of software code for execution by the applications 103, as well as additional or alternative aspects of a given software development process.

In some embodiments, one or more of the estimates for completion of respective work items of the software development process are generated at least in part by at least one of the first and second LLM agents.

Additionally or alternatively, one or more of the estimates for completion of respective work items of the software development process may be generated at least in part by the at least one LLM.

In some embodiments, the above-noted method further comprises training the at least one LLM.

For example, the at least one LLM may illustratively comprise a generative pre-trained transformer (GPT) model. In such an embodiment, training the at least one LLM may more particularly comprise fine-tuning the GPT model to generate estimates as respective story point values.

As another example, training the at least one LLM in some embodiments comprises pre-training a given LLM utilizing a plurality of completed user stories and respective corresponding story point values. A given one of the user stories is illustratively associated with one or more code changes to at least one application.

In some embodiments, the first role assigned to the first LLM agent comprises a product owner role focused on a relationship between implementation effort and story points, and the second role assigned to the second LLM agent comprises a software engineer role focused on a relationship between user story requirements and implementation effort. Additional or alternative roles in the software development process can be assigned to respective ones of the LLM agents 112 in other embodiments.

At least one of the first and second LLM agents is illustratively configured to incorporate self-reflection functionality to determine one or more aspects of its corresponding relationship focus.

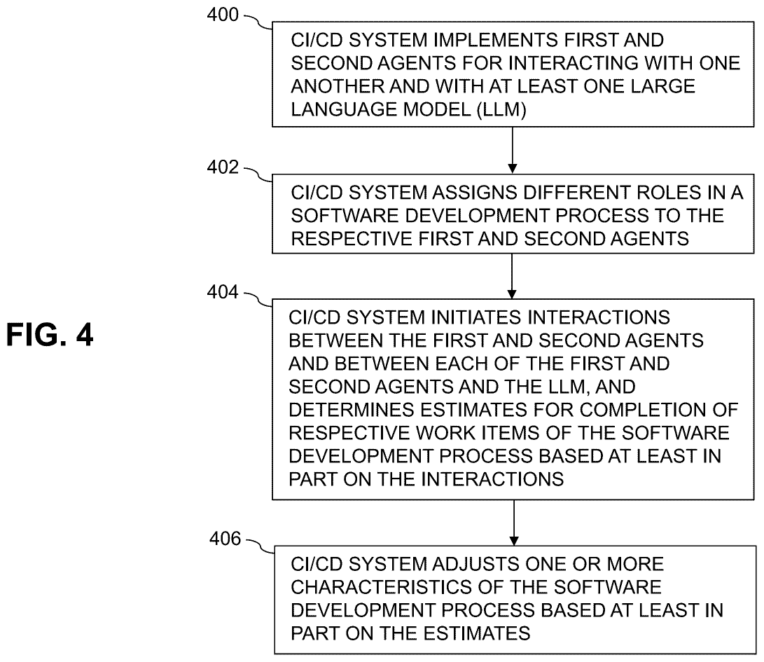

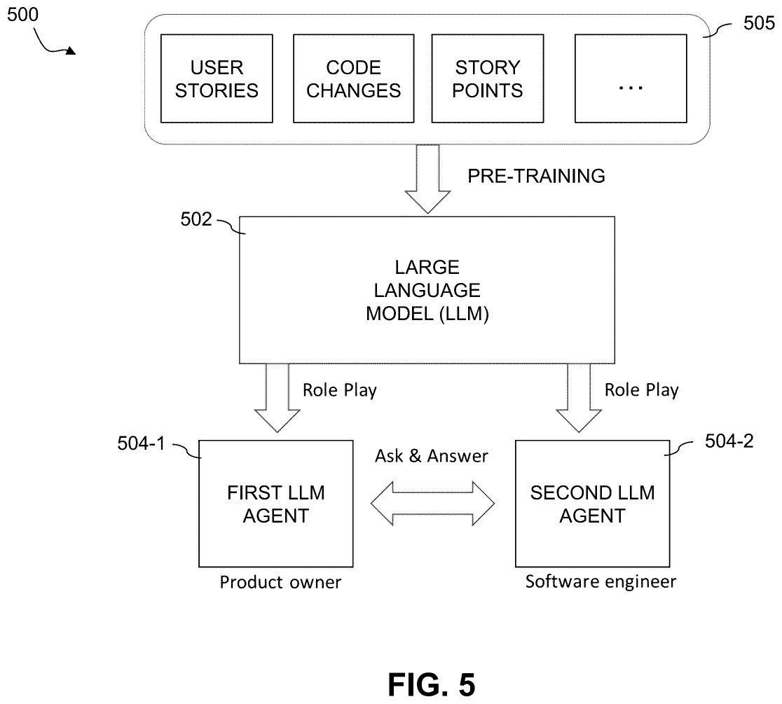

Additional aspects of the operation of the LLM agents 112 and other software-based agents configured to interact with one or more LLMs will be described below in conjunction with the illustrative embodiments of FIGS. 4 and 5.

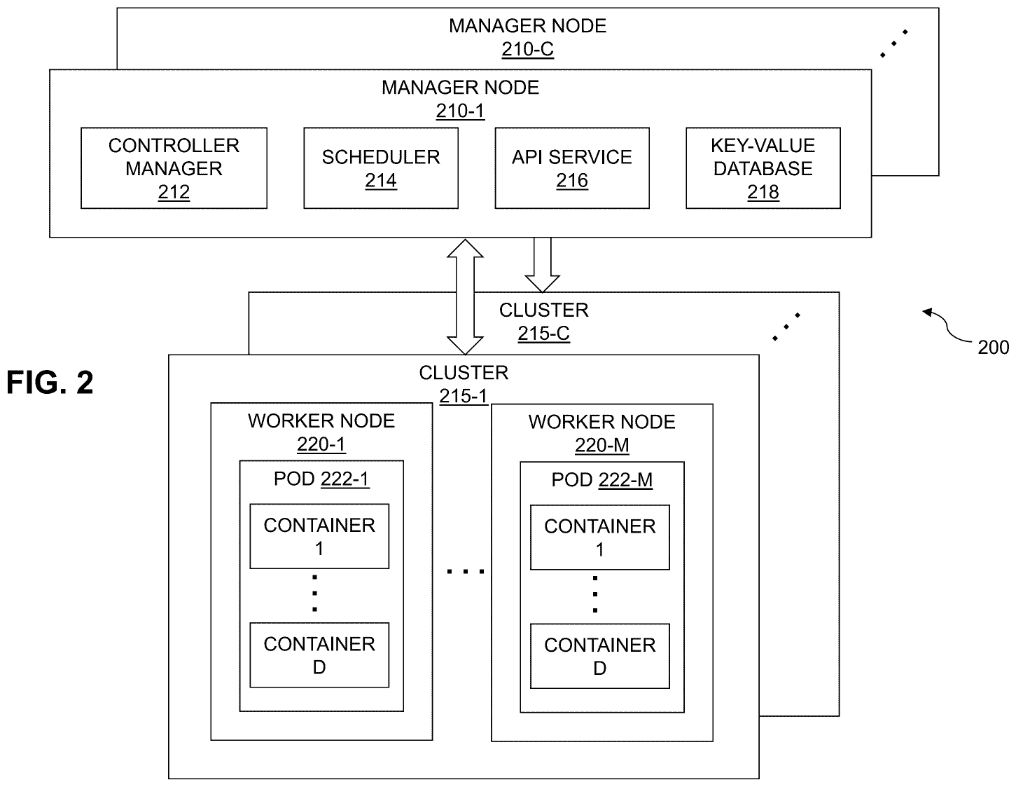

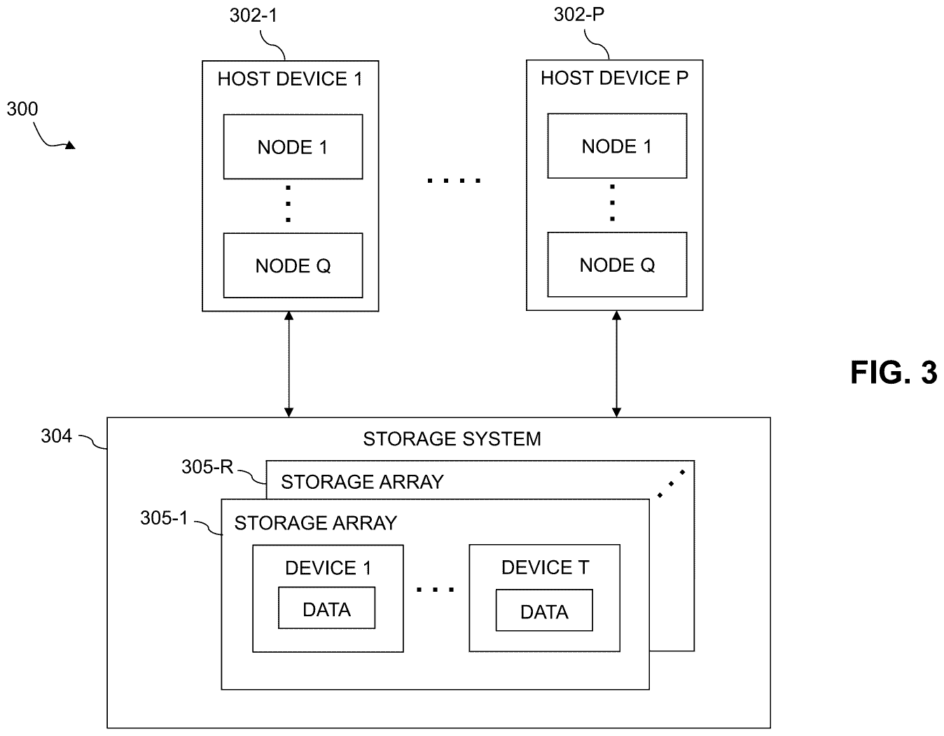

It should be noted that the host platform 101 that receives software code from the CI/CD system 106 can take on any of a number of different configurations. For example, in some embodiments, the host platform 101 implements a plurality of containers for implementing respective sets of one or more of the applications 103, as will now be described in more detail with reference to FIGS. 2 and 3.

As the term is illustratively used herein, a “container” may be considered lightweight, stand-alone, executable software code that includes elements needed to run the software code. The container structure has many advantages including, but not limited to, isolating the software code from its surroundings, and helping reduce conflicts between different tenants or users running different software code on the same underlying infrastructure. As indicated above, the term “user” herein is intended to be broadly construed so as to encompass numerous arrangements of human, hardware, software or firmware entities, as well as combinations of such entities.

In illustrative embodiments, containers may be implemented using a Kubernetes container orchestration system. Kubernetes is an open-source system for automating application deployment, scaling, and management within a container-based information processing system comprised of components referred to as pods, nodes and clusters, as will be further explained below in the context of FIG. 2. Types of containers that may be implemented or otherwise adapted within the Kubernetes system include, but are not limited to, Docker containers or other types of Linux containers (LXCs) or Windows containers. Kubernetes has become the prevalent container orchestration system for managing containerized workloads. While the Kubernetes container orchestration system is used to illustrate various embodiments, it is to be understood that alternative container orchestration systems can be utilized.

Some terminology associated with the Kubernetes container orchestration system will now be explained. In general, for a Kubernetes environment, one or more containers are part of a pod. Thus, the environment may be referred to, more generally, as a pod-based system, a pod-based container system, a pod-based container orchestration system, a pod-based container management system, or the like. As mentioned above, the containers can be any type of container, e.g., Docker container, etc. Furthermore, a pod is typically considered the smallest execution unit in the Kubernetes container orchestration environment. A pod encapsulates one or more containers. One or more pods are executed on a worker node, and multiple worker nodes form a cluster. A Kubernetes cluster is managed by at least one manager node. A Kubernetes environment may include multiple clusters respectively managed by multiple manager nodes. Furthermore, pods typically represent the respective processes running on a cluster. A pod may be configured as a single process wherein one or more containers execute one or more functions that operate together to implement the process. Pods may each have a unique IP address enabling pods to communicate with one another, and for other system components to communicate with each pod. Still further, pods may each have persistent storage volumes associated therewith. Configuration information (e.g., one or more configuration objects) indicating how a container executes can be specified for each pod.

FIG. 2 shows an example of a pod-based container orchestration environment 200 that in some embodiments is used to implement at least portions of the host platform 101. As shown, a plurality of manager nodes 210-1, . . . 210-C, collectively referred to as manager nodes 210, are respectively operatively coupled to a plurality of clusters 215-1, . . . 215-C, collectively referred to as clusters 215. As indicated above, each of the clusters 215 is managed by at least one manager node.

Each of the clusters 215 comprises a plurality of worker nodes 220-1, . . . 220-M, collectively referred to as worker nodes 220. Each worker node 220 comprises a respective pod, i.e., one of a plurality of pods 222-1, . . . 222-M, collectively referred to as pods 222. However, it is to be understood that one or more worker nodes 220 can run multiple pods 222 at a time. Each pod 222 comprises a set of containers denotes as Container 1, . . . . Container D, although each pod may also have a different number of containers. As used herein, a pod may be referred to more generally as a containerized workload. Also shown in FIG. 2, each of the manager nodes 210 comprises a controller manager 212, a scheduler 214, an application programming interface (API) service 216, and a key-value database 218, as will be further explained. However, in some embodiments, multiple ones of the manager nodes 210 may share one or more of the same controller manager 212, scheduler 214, API service 216, and key-value database 218.

Worker nodes 220 of each of the clusters 215 execute one or more applications associated with pods 222 (e.g., containerized workloads). Each of the manager nodes 210 manages the worker nodes 220, and therefore pods 222 and containers, in its corresponding cluster 215. More particularly, each of the manager nodes 210 controls operations in its corresponding cluster 215 utilizing the above-mentioned components, i.e., controller manager 212, scheduler 214, API service 216, and key-value database 218. In general, controller manager 212 executes control processes (e.g., controllers) that are used to manage operations in cluster 215. Scheduler 214 typically schedules pods to run on particular nodes taking into account node resources and application execution requirements such as, but not limited to, deadlines. In general, in a Kubernetes implementation, API service 216 exposes the Kubernetes API, which is the front end of the Kubernetes container orchestration system. Key-value database 218 typically provides key-value storage for all cluster data including, but not limited to, configuration data objects generated, modified, deleted, and otherwise managed, during the course of system operations.

Turning now to FIG. 3, an information processing system 300 is depicted within which pod-based container orchestration environment 200 of FIG. 2 can be implemented. The information processing system 300 may be viewed as comprising at least a portion of the host platform 101 of system 100. More particularly, as shown in FIG. 3, a plurality of host devices 302-1, . . . 302-P, collectively referred to as host devices 302, are operatively coupled to a storage system 304. Each host device 302 hosts a set of nodes denoted as Node 1, . . . . Node Q. As indicated previously, one non-limiting example of a host device 302 is a server. Note that while multiple nodes are illustrated on each host device 302, a host device 302 can host a single node, and one or more host devices 302 can host a different number of nodes as compared with one or more other host devices 302.

As is further shown in FIG. 3, storage system 304 comprises a plurality of storage arrays 305-1, . . . 305-R, collectively referred to as storage arrays 305, each of which is comprised of a set of storage devices denoted as Device 1, . . . . Device T, upon which data of one or more storage volumes is persisted. The storage volumes for which data is stored in the storage devices of each storage array 305 can include any data generated in the information processing system 300 but, more typically, include data generated, manipulated, or otherwise accessed, during the execution of one or more applications in the nodes of host devices 302.

Furthermore, any one of nodes Node 1, . . . . Node Q on a given host device 302 can be a manager node 210 or a worker node 220. In some embodiments, a node can be configured as a manager node for one execution environment and as a worker node for another execution environment. Thus, the components of a pod-based container orchestration environment 200 in FIG. 2 can be implemented on one or more of host devices 302, such that data associated with pods 222 running on the nodes Node 1, . . . . Node Q is stored as persistent storage volumes in one or more of the storage devices Device 1, . . . . Device T of one or more of storage arrays 305.

Host devices 302 and storage system 304 of information processing system 300 are assumed to be implemented using at least one processing platform comprising one or more processing devices each having a processor coupled to a memory. Such processing devices can illustratively include particular arrangements of compute, storage and network resources. In some alternative embodiments, one or more host devices 302 and storage system 304 can be implemented on respective distinct processing platforms.

The term “processing platform” as used herein is intended to be broadly construed so as to encompass, by way of illustration and without limitation, multiple sets of processing devices and associated storage systems that are configured to communicate over one or more networks. For example, distributed implementations of an information processing system are possible, in which certain components of the system reside in one data center in a first geographic location while other components of the system reside in one or more other data centers in one or more other geographic locations that are potentially remote from the first geographic location. Thus, it is possible in some implementations of an information processing system for portions or components thereof to reside in different data centers. Numerous other distributed implementations of an information processing system are possible. Accordingly, the constituent parts of information processing systems as disclosed herein can also be implemented in a distributed manner across multiple computing platforms.

As indicated above, the deployment of a microservice or other application on a host platform (e.g., a Kubernetes cluster) in some embodiments illustratively utilizes separate source and deployment repositories for the microservice or other application, with the source repository containing the microservice business logic or other application logic and the deployment repository containing the deployment configurations for the microservice or other application. In other embodiments, the source and deployment repositories may be combined into a single repository.

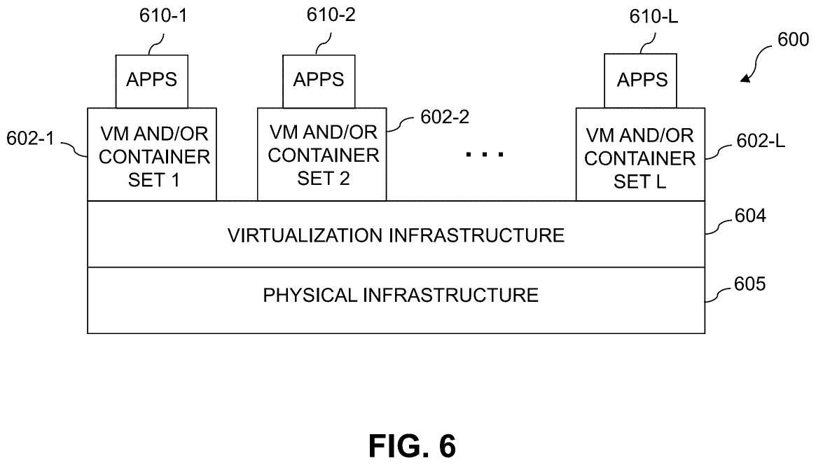

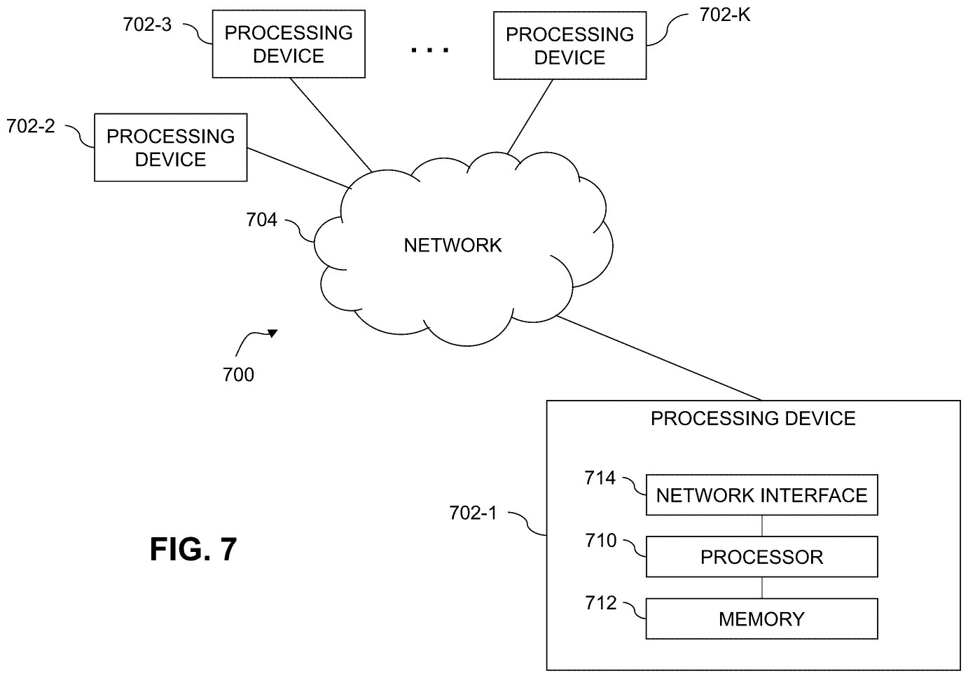

Additional examples of processing platforms utilized to implement a host platform and/or an associated software development system will be described in more detail below in conjunction with FIGS. 6 and 7.

It is to be appreciated that these and other features of illustrative embodiments are presented by way of example only, and should not be construed as limiting in any way. Accordingly, different numbers, types and arrangements of system components can be used in other embodiments. The particular sets of components implemented in the illustrative embodiments of FIGS. 1 through 3 are therefore presented by way of example only. In other embodiments, only subsets of these components, or additional or alternative sets of components, may be used, and such components may exhibit alternative functionality and configurations. Additional examples of such embodiments will be described below.

An example process for automated generation of story points or other estimates using multiple LLM agents will now be described in more detail with reference to the flow diagram of FIG. 4. It is to be understood that this particular process is only an example, and that additional or alternative processes for estimate generation using multiple LLM agents may be used in other embodiments.

In this embodiment, the example process includes steps 400 through 406. These steps are assumed to be performed by a CI/CD system, such as the CI/CD system 106 of the software development platform 105 in system 100, utilizing multiple LLM agents such as the LLM agents 112 of the CI/CD system 106.

In step 400, a CI/CD system implements first and second agents for interacting with one another and with at least one LLM. Such agents are also referred to herein as “software-based agents” or LLM agents. In some embodiments, the first and second agents interact with the same LLM, although it is possible that the first and second agents in other embodiments can interact with different LLMs, such as different versions of a given LLM. Numerous other arrangements are possible. For example, in some embodiments, at least portions of the one or more LLMs can be incorporated into at least one of the first and second agents.

In step 402, the CI/CD system assigns different roles in a software development process to the respective first and second agents. For example, in some embodiments, a first role assigned to the first agent comprises a product owner role focused on a relationship between implementation effort and story points and a second role assigned to the second agent comprises a software engineer role focused on a relationship between user story requirements and implementation effort. At least one of the first and second agents in one or more such embodiments is illustratively configured to incorporate self-reflection functionality to determine one or more aspects of its corresponding relationship focus. Additional or alternative roles can be assigned to the respective agents in other embodiments, and more than two agents can be used.

In step 404, the CI/CD system initiates interactions between the first and second agents and between each of the first and second agents and the LLM, and determines estimates for completion of respective work items of the software development process based at least in part on the interactions. For example, in some embodiments, the software development process comprises an agile software development process, and the estimates comprise respective story point values for respective user stories that provide descriptions of the respective work items. Other types of estimates can be used in other embodiments based on the interactions between the first and second agents and between each of the first and second agents and the LLM. In some embodiments, the LLM is implemented on an external platform, and the first and second agents communicate with the LLM over one or more networks via API calls or other suitable communication mechanisms.

In step 406, the CI/CD system adjusts one or more characteristics of the software development process based at least in part on the estimates. For example, the CI/CD system illustratively controls one or more aspects of at least one of integration, deployment and/or delivery of software code to one or more applications of a host platform based at least in part on the estimates. This can involve, also by way of example, modifying the duration, sequencing, scheduling and/or other characteristics of one or more “sprints,” which are short, time-bounded periods in which a scrum team works to complete a set amount of work, where a “scrum team” refers to an agile project management framework involving multiple software developers and associated development resources. It is to be appreciated that such control actions or other adjustments as used herein are intended to be broadly construed. Numerous other adjustments can be made to additional or alternative characteristics of a software development process utilizing automatically-generated estimates as disclosed herein.

One or more of steps 400 through 406 are illustratively repeated over time in order to support the disclosed functionality for implementing software development with multiple LLM agents. Multiple such processes may operate at least in part in parallel with one another for different applications or sets of applications.

The steps of the FIG. 4 process are shown in sequential order for clarity and simplicity of illustration only, and certain steps can at least partially overlap with other steps. Additional or alternative steps can be used in other embodiments to implement the disclosed software development functionality. The particular processing operations and other system functionality described in conjunction with the flow diagram of FIG. 4 are therefore presented by way of illustrative example only, and should not be construed as limiting the scope of the disclosure in any way.

Functionality such as that described in conjunction with the flow diagram of FIG. 4 can be implemented at least in part in the form of one or more software programs stored in memory and executed by a processor of a processing device such as a computer or server. A memory or other storage device having executable program code of one or more software programs embodied therein is an example of what is more generally referred to herein as a “processor-readable storage medium.”

Additional illustrative embodiments will now be described with reference to FIG. 5.

FIG. 5 shows an example of automated story pointing in a software development process utilizing multiple LLM agents in an illustrative embodiment.

As indicated above, in an agile development process, a story point value is typically used to measure the effort needed to implement a user story. A given story point value is also referred to herein as comprising one or more story points. Scrum teams mainly rely on tools like “planning poker” to estimate the story points. However, the effort estimation is often inaccurate. Published research studies show that about 10% of the work items in certain studied projects have story points changes after they were assigned to a sprint. In one or more such studies, an average of 57% of the work items have their story points increased by at least 58% relative to the story points that were initially assigned. Such underestimations of effort are increasingly common, particularly when a scrum team gets into unfamiliar domains.

Inaccurate estimations can mean that the user stories will not be completed in the sprint, which implies the sprint goal may not be met. This will have a negative impact on the whole software development process, in that an important time point may be missed or even committed product delivery items may not be delivered on time to the customer.

Illustrative embodiments disclosed herein address these and other drawbacks of conventional practice by implementing automated story pointing with the assistance of at least first and second LLM agents configured to interact with one or more LLMs. In some embodiments, the LLM is pre-trained with completed user stories, including requirement descriptions of the stories, effort implemented in the stories (e.g., code changes, document changes, time span changes and so on) and the corresponding story points.

As shown in FIG. 5, an example CI/CD system 500 comprises an LLM 502 and first and second LLM agents 504-1 and 504-2. Also included in the CI/CD system is a database 505 that includes user stories, code changes, story points and other software development information that is illustratively used to pre-train the LLM 502. Although the LLM 502 is illustratively shown in this embodiment as being part of the CI/CD system 500, this is by way of illustrative example only, and in other embodiments the LLM 502 may be implemented at least in part externally to the CI/CD system 500 and its associated software development platform, such as on an external processing platform accessible over a network as previously described. Also, as indicated previously, other embodiments can include more than two LLM agents 504, each illustratively assigned a different role in a software development process.

In the CI/CD system 500, the first LLM agent 504-1 is illustratively assigned to play the role of software engineer and to focus on the relationship between requirements and implementation effort, while the second LLM agent 504-2 is illustratively assigned to play the role of product owner and to focus on the relationship between implementation effort and story points. Techniques such as self-reflection may be utilized in training of the LLM agents 504, as will be appreciated by those skilled in the art.

Interactions between the LLM agents 504 illustratively include various types of “ask and answer” interaction as shown. Also, each of the LLM agents 504 interacts with the LLM 502 through respective “role play” interactions as shown, in conjunction with playing their respective assigned roles in the software development process.

For example, in conjunction with automated story pointing, the product owner agent will illustratively ask the software engineer agent a set of questions to get more detailed information about the effort required to complete the story, in some embodiments using CoT techniques. The product owner agent, utilizing the information provided by software engineer agent, will determine an estimation for the story. With the requirements broken into a detailed effort to complete the story, it will be more understandable why the story is assigned particular story points, which means the whole story pointing process is more transparent and explainable. It is also much easier to analyze why the results provided by the automated story pointing in illustrative embodiments may deviate from conventional estimates provided by human actors, allowing further refinements in the LLM 502 through additional training.

In some embodiments, the LLM 502 is initially pre-trained utilizing completed user stories and their associated code changes and story points, and possibly additional or alternative information from the database 505, and then the LLM 502 and the LLM agents 504 are configured to collaboratively perform the automated story pointing as disclosed herein. Additional aspects of such features of illustrative embodiments are further described below.

### Pre-Training of the LLM

The LLM 502 is illustratively pre-trained with completed stories including requirement descriptions of the stories, effort implemented in the stories (e.g., code changes, document changes, time taken to finish the story and so on) and the corresponding story points.

A wide variety of different techniques can be used to the LLM 502 utilizing such information, including the following examples:

1. LLMs such as ChatGPT or Llama can be fine-tuned with a dataset provided or otherwise designated by a system user. Accordingly, such a dataset comprising the above-noted completed user story information can be provided to a given instance of the LLM for fine tuning of the LLM.

2. For custom LLMs, the above-noted completed user story information can be provided to the LLM for training directly just like other documents used for LLM training.

### Story Pointing Using the Pre-Trained LLM

As indicated previously, the LLM agents 504 are assigned to play the respective roles of product owner and software engineer, and the LLM 502 supports role play interactions with the respective LLM agents 504 for both of these distinct roles. The role playing allows the corresponding LLM agent to be focused on its corresponding domain within the software development process.

For the LLM agent assigned the role of software engineer, self-reflection is illustratively used to construct the relationship between requirement and code changes. By way of example, the software engineer agent in some embodiments will ask itself questions like: “For the requirement, which source files are modified?” “Which components in the product are impacted?” and “What functions are added into the component?” With such self-reflection, the software engineer agent will clarify the change scope for different requirements, so that the accuracy of its answers will be improved.

For the LLM agent assigned the role of product owner, self-reflection is illustratively used to construct the relationship between change scope and story points. The product owner agent in some embodiments will ask itself questions like “For changes like this, how many story points should be assigned?” and “For the functions added, how much time will it cost to complete the task?” With such self-reflection, the product owner agent will clarify the story points for different change scopes, so that the accuracy of its answers will be improved.

The above-described self-reflection will lead the LLM agents 504 to extract correct concepts from their memories, utilizing the LLM 502 which is illustratively trained with large amounts of completed user story information. The self-reflection is supported by the LLM 502 in accordance with the role play interactions.

The LLM agents 504 also work in a collaborative way via the above-noted ask and answer interactions. For example, the product owner agent may provide story requirements to the software engineer agent, and ask it questions about effort estimation to complete the story. Such questions may be asked using CoT techniques, and may include questions such as: “Which components will be impacted to fulfill the requirement?” “Which functions in component X will be updated?” and “How long may it take to finish the change in function Y?”

In this CoT approach, the effort to finish the story is broken down from a top level, which will be much better than just asking “How long will it take to finish the story?” The CoT approach will encourage the software engineer agent to think in a more logical way leveraging the knowledge built previously.

In some embodiments, the product owner agent will determine the story points for a given user story based at least in part on one or more answers provided by the software engineer agent using the CoT approach.

For example, after receiving the answers from software engineer agent, the product owner agent obtains information such as the change scope for the story, including components impacted, functions updated, and rough time estimation for the story. In the self-reflection described previously, the product owner agent has already focused on the impact of these factors, so based on this information, the product owner agent will provide a reasonable story point estimation. Utilizing the answers that it obtains from the software engineer agent, the product owner agent can, for example, provide a system user with the story points for a given user story that has a scope change. In such an arrangement, the system user can obtain the story points estimate by asking the product owner agent “With this scope change, how many story points should be assigned to this story?”

Again, the particular features and functionality of the embodiments of FIGS. 4 and 5 as described above are presented by way of illustrative example only, and can be varied in other embodiments.

These and other illustrative embodiments disclosed herein can provide a number of significant advantages relative to conventional arrangements.

For example, illustrative embodiments provide automated generation of story point values or other estimates for completion of work items in a software development process utilizing multiple LLM agents which are configured to interact with one or more LLMs.

In some embodiments, a given story pointing task is split into sub-tasks associated with respective roles in a software development process and each LLM agent focuses on one simpler sub-task in accordance with its assigned role.

Self-reflection is implemented in some embodiments in each role played by an LLM agent in order to build accurate connections between change scopes and requirements and between story points and change scopes. With self-reflection, a given agent obtains additional clarity and insights into its particular area of focus.

In some embodiments, CoT techniques are utilized, for example, to lead an LLM agent to find a correct change scope for new requirements. With such a CoT approach, the LLM agent can break the requirements into implementation effort in a logical way, such that it can provide a more accurate effort estimation.

These and other embodiments provide a clear decision flow, such as requirements to implementation efforts to story points, allowing a system user to check each step to decide if the outcome is as expected.

Accordingly, some embodiments facilitate the adaptation of the operation of the LLM and its associated LLM agents over time through further training in order to provide additional improvements.

Moreover, illustrative embodiments are highly flexible and expandable. For example, the pre-trained LLM is not limited to story pointing, but can additionally or alternatively be configured to support other roles such as product manager, software architect and so on. Accordingly, additional tasks in an agile software development process, such as backlog refinement and sprint planning, can be completed utilizing the LLM and its associated LLM agents.

As more and more product teams are leveraging agile project management, the disclosed arrangements can be advantageously applied to multiple such teams in a wide variety of different software development contexts.

For example, such arrangements can improve the efficiency of an established scrum team while also allowing those teams that are just starting out with agile project management to fit into a scrum process more easily and quickly.

It is to be appreciated that the particular advantages described above and elsewhere herein are associated with particular illustrative embodiments and need not be present in other embodiments.

Also, the particular types of information processing system features and functionality as illustrated and described herein are exemplary only, and numerous other arrangements may be used in other embodiments.

Illustrative embodiments of processing platforms utilized to implement functionality for automated generation of story points or other estimates using multiple LLM agents as disclosed herein will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that may be utilized to implement at least a portion of the information processing system 100. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 may comprise respective VMs, respective sets of one or more containers, or respective sets of one or more containers running in VMs.

In some implementations of the FIG. 6 embodiment, the VMs/container sets 602 comprise respective VMs implemented using virtualization infrastructure 604 that comprises at least one hypervisor. Such implementations can provide automated generation of estimates and/or associated adjustments in software development characteristics using one or more processes running on a given one of the VMs. For example, each of the VMs can implement logic instances and/or other components for providing at least portions of the above-described functionality for automated story pointing using multiple LLM agents 112 in the system 100.

A hypervisor platform may be used to implement a hypervisor within the virtualization infrastructure 604. Such a hypervisor platform may comprise an associated virtual infrastructure management system. The underlying physical machines may comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system. Such implementations can also provide automated generation of estimates and/or associated adjustments in characteristics of software development processes. For example, a container host supporting multiple containers of one or more container sets can implement logic instances and/or other components for providing at least portions of the above-described functionality for automated story pointing using multiple LLM agents 112 in the system 100.

As is apparent from the above, one or more of the processing devices or other components of system 100 may each run on a computer, server, storage device or other processing platform element. A given such element may be viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 702-1 in the processing platform 700 comprises a processor 710 coupled to a memory 712.

The processor 710 may comprise, for example, a microprocessor, a microcontroller, an application-specific integrated circuit (ASIC), a field-programmable gate array (FPGA), a central processing unit (CPU), a graphics processing unit (GPU), a tensor processing unit (TPU) and/or other types of processing circuitry, as well as portions or combinations of these or other circuitry elements.

The memory 712 may comprise, for example, random access memory (RAM), read-only memory (ROM), flash memory or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise various arrangements of converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the dynamic resource adjustment functionality provided by one or more components of a storage system as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, host platforms, host devices, microservices or other applications, software development platforms, CI/CD systems, LLMs, LLM agents, software development processes, and additional or alternative components. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
configuring a software development process to include at least first and second software-based agents for interacting with one another and with at least one large language model;
assigning a first role in the software development process to the first software-based agent;
assigning a second role in the software development process, different than the first role in the software development process, to the second software-based agent;
initiating interactions between the first and second software-based agents and between each of the first and second software-based agents and the at least one large language model;
determining estimates for completion of respective work items of the software development process based at least in part on the interactions; and
adjusting one or more characteristics of the software development process based at least in part on the estimates;
wherein the method is performed by at least one processing device comprising a processor coupled to a memory.

2. The method of claim 1 wherein the software development process is part of a continuous integration/continuous deployment (CI/CD) system that controls software code for one or more applications executed by host devices of a host platform coupled to the CI/CD system over at least one network.

3. The method of claim 1 wherein the software development process comprises an agile software development process and the estimates comprise respective story point values of the agile software development process.

4. The method of claim 3 wherein the story point values are generated based at least in part on respective user stories providing descriptions of the respective work items of the agile software development process.

5. The method of claim 1 wherein one or more of the estimates for completion of respective work items of the software development process are generated at least in part by at least one of the first and second software-based agents.

6. The method of claim 1 wherein one or more of the estimates for completion of respective work items of the software development process are generated at least in part by the at least one large language model.

7. The method of claim 1 wherein further comprising training the at least one large language model.

8. The method of claim 7 wherein the at least one large language model comprises a generative pre-trained transformer model and training the at least one large language model comprises fine-tuning the generative pre-trained transformer model to generate estimates as respective story point values.

9. The method of claim 7 wherein training the at least one large language model comprises pre-training a given large language model utilizing a plurality of completed user stories and respective corresponding story point values, and wherein a given one of the user stories is associated with one or more code changes to at least one application.

10. The method of claim 1 wherein the first role assigned to the first software-based agent comprises a product owner role focused on a relationship between implementation effort and story points and the second role assigned to the second software-based agent comprises a software engineer role focused on a relationship between user story requirements and implementation effort.

11. The method of claim 10 wherein at least one of the first and second software-based agents is configured to incorporate self-reflection functionality to determine one or more aspects of its corresponding relationship focus.

12. A computer program product comprising a non-transitory processor-readable storage medium having stored therein program code of one or more software programs, wherein the program code when executed by at least one processing device causes the at least one processing device:
to configure a software development process to include at least first and second software-based agents for interacting with one another and with at least one large language model;
to assign a first role in the software development process to the first software-based agent;
to assign a second role in the software development process, different than the first role in the software development process, to the second software-based agent;
to initiate interactions between the first and second software-based agents and between each of the first and second software-based agents and the at least one large language model;
to determine estimates for completion of respective work items of the software development process based at least in part on the interactions; and
to adjust one or more characteristics of the software development process based at least in part on the estimates.

13. The computer program product of claim 12 wherein the software development process comprises an agile software development process and the estimates comprise respective story point values of the agile software development process, and further wherein the story point values are generated based at least in part on respective user stories providing descriptions of the respective work items of the agile software development process.

14. The computer program product of claim 12 wherein the program code when executed further causes the at least one processing device to train the at least one large language model, wherein the at least one large language model comprises a generative pre-trained transformer model and training the at least one large language model comprises fine-tuning the generative pre-trained transformer model to generate estimates as respective story point values.

15. An apparatus comprising:
at least one processing device comprising a processor coupled to a memory;
the at least one processing device being configured:
to implement a software development process to include at least first and second software-based agents for interacting with one another and with at least one large language model;
to assign a first role in the software development process to the first software-based agent;
to assign a second role in the software development process, different than the first role in the software development process, to the second software-based agent;
to initiate interactions between the first and second software-based agents and between each of the first and second software-based agents and the at least one large language model;
to determine estimates for completion of respective work items of the software development process based at least in part on the interactions; and
to adjust one or more characteristics of the software development process based at least in part on the estimates.

16. The apparatus of claim 15 wherein the software development process comprises an agile software development process and the estimates comprise respective story point values of the agile software development process, and further wherein the story point values are generated based at least in part on respective user stories providing descriptions of the respective work items of the agile software development process.

17. The apparatus of claim 15 wherein the at least one processing device is further configured to train the at least one large language model, wherein the at least one large language model comprises a generative pre-trained transformer model and training the at least one large language model comprises fine-tuning the generative pre-trained transformer model to generate estimates as respective story point values.

18. The apparatus of claim 15 wherein the at least one processing device is further configured to train the at least one large language model, wherein training the at least one large language model comprises pre-training a given large language model utilizing a plurality of completed user stories and respective corresponding story point values, and wherein a given one of the user stories is associated with one or more code changes to at least one application.

19. The apparatus of claim 15 wherein the first role assigned to the first software-based agent comprises a product owner role focused on a relationship between implementation effort and story points and the second role assigned to the second software-based agent comprises a software engineer role focused on a relationship between user story requirements and implementation effort.

20. The apparatus of claim 19 wherein at least one of the first and second software-based agents is configured to incorporate self-reflection functionality to determine one or more aspects of its corresponding relationship focus.
